(19) United States
(12) Patent Application Publication
(10) Pub. No.: US 2025/0309577 A1
(43) Pub. Date: Oct. 2, 2025

(54) ELECTRICAL CONNECTOR WITH IMPROVED TERMINAL PASSAGEWAYS

(71) Applicants: Foxconn (Kunshan) Computer Connector Co.,Ltd., Kunshan (CN); foxconn Interconnect Technology Limited, Grand Cayman (KY)

(72) Inventor: SHUO-HSIU HSU, Phoenix, AZ (US)

(21) Appl. No.: 18/616,852

(22) Filed: Mar. 26, 2024

(51) Int. Cl. H01R 13/422; H01R 12/70; H01R 12/75

(52) U.S. Cl. CPC H01R 13/422; H01R 12/75; H01R 12/707

(57) ABSTRACT

An electrical connector includes: an insulating housing defining opposite mating face and mounting face and having plural passageways arranged in an array and running through the mating face and the mounting face, each passageway having a retaining slot and a receiving hole communicating with each other; plural terminals each comprising a retaining portion retained in the retaining slot, a mating portion, and a cable-contacting face which orients the receiving hole, wherein viewed in a mating direction of the electrical connector each of the receiving hole has a hemicycle part, the terminals are adapted to connect with soldering balls or cables, and conductive ends of the cables are inserted in the receiving holes and positioned between the hemicycle parts and corresponding contacting faces when the terminals are connected with the cables.

### BACKGROUND OF THE INVENTION

### 1. Field of the Invention

The present invention relates to an electrical connector.

### 2. Description of Related Arts

CN 216120831 U discloses a wire-to-board connector, which comprises an insulating housing with a plurality of holes and plurality of terminals fixed in the holes. Each terminal has a main portion, an elastic arm extending upwardly from the main portion, and a soldering portion extending downwardly from the main portion. An interposer is added and located below the insulating housing. The upper surface of the interposer has a plurality of first pads, which are connected with soldering portions of the terminals. The lower surface of the interposed has a plurality of second pads, which are connected with a plurality of cables. The connection of the cables and the terminals is achieved by the interposer, which increase the constructive complexity of the wire-to-board connector.

Therefore, an improved electrical connector is desired to overcome the disadvantages of the prior art.

### SUMMARY OF THE INVENTION

An object of the present invention is to provide an electrical connector with improved terminal passageways.

In order to achieve above-mentioned object, an electrical connector comprises: an insulating housing defining a mating face and a mounting face opposite to the mating face and having a plurality of passageways arranged in an array and running through the mating face and the mounting face, each passageway having a retaining slot and a receiving hole communicating with each other; and a plurality of terminals each comprising a retaining portion retained in the retaining slot, a mating portion, and a cable-contacting face oriented at the receiving hole, wherein viewed in a mating direction of the electrical connector each of the receiving hole has a hemicycle part; the terminals are adapted to connect with soldering balls or cables; and the hemicycle parts and corresponding cable-contacting faces position conductive ends of the cables when the terminals are connected with the cables.

Other objects, advantages and novel features of the present invention will become more apparent from the following detailed description of the present embodiment when taken in conjunction with the accompanying drawings.

### BRIEF DESCRIPTION OF THE DRAWING

FIG. 1 is a cross-sectional view of an electrical connector assembly of a first embodiment of the present invention;

FIG. 2 is a perspective view of a first electrical connector and a second electrical connector of the assembly in FIG. 1, which are unmated from each other with one row of terminals are taken away from each of the connector;

FIG. 3 is another perspective view of the assembly in FIG. 2;

FIG. 4 is an exploded perspective view of two rows of terminals and soldering balls taken away from the two connectors in FIG. 2;

FIG. 5 is another perspective view of one terminal of the first connector in FIG. 4;

FIG. 6 is a bottom plane view of the first connector in FIG. 4;

FIG. 7 is a perspective view of a first electrical connector of a second embodiment of this present invention, with one row of terminals and cables taken away;

FIG. 8 is an exploded perspective view of the one row of terminals and cables;

FIG. 9 is another perspective view of the first electrical connector in FIG. 7;

FIG. 10 is a bottom plane view of the first connector in FIG. 9;

FIG. 11 is a cross-sectional view of the first electrical connector taken along lines A-A in FIG. 7;

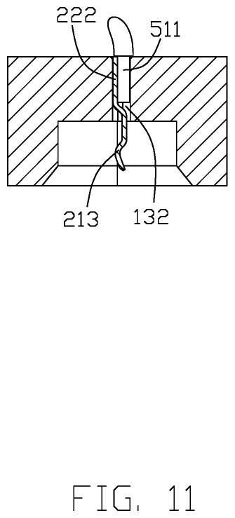

FIG. 12 is a perspective view of a first electrical connector of a third embodiment of this present invention, with one row of terminals and cables taken away;

FIG. 13 is another perspective view of the first electrical connector in FIG. 12;

FIG. 14 is a bottom plane view of the first connector in FIG. 13; and

FIG. 15 is a cross-sectional view of the first electrical connector taken along lines B-B in FIG. 12.

### DETAILED DESCRIPTION OF THE PREFERRED EMBODIMENTS

Reference will now be made in detail to the preferred embodiments of the present invention.

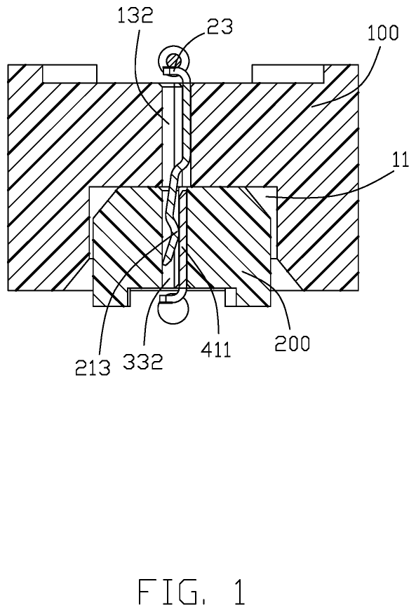

Referring to FIGS. 1-6 illustrating an electrical connector assembly of a first embodiment of this present invention, the assembly includes a first electrical connector 100 and a second electrical connector 200, the first connector 100 has a receiving cavity 11 to receive the second connector 200 so as to get an electrical connection of the two connectors. The first and the second connectors each includes an insulating housing with a mating face and a plurality of conductive terminals retained in the insulating housing.

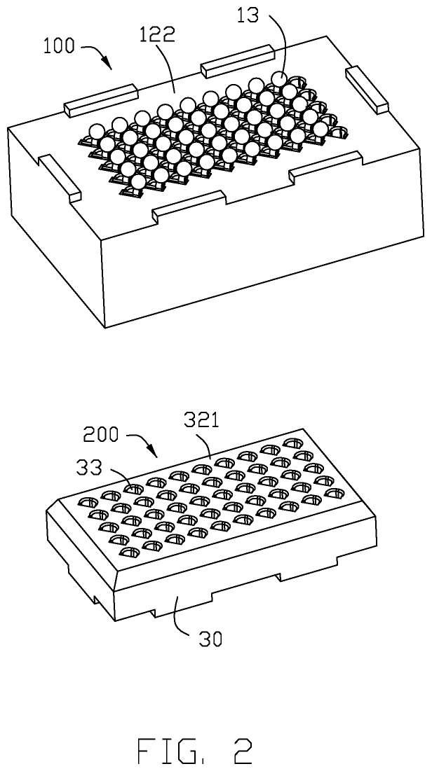

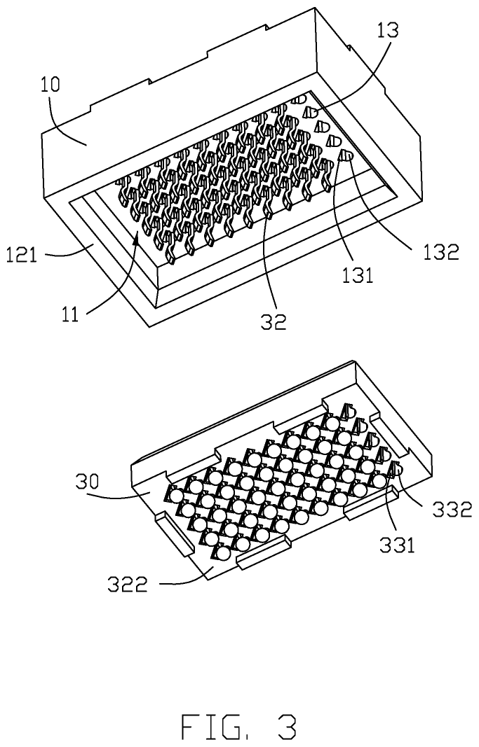

Referring to FIGS. 2-3, the receiving cavity 11 is recessed from the mating face 121 of the insulating housing 10 of the first connector 100. Plural rows of passageways 13 run through a mounting face 122 and the mating face 121, in this embodiment, the mounting face 121 is on a lower face of the insulating housing 10 and the mating face 121 is on a lower face of the insulating housing 10, that is, the mating face and the mounting face are disposed opposite to each other. The insulating housing 30 of the second connector 200 has plural rows of the terminal passageways 33 running through a mating face 321 and the mounting face 322. In this embodiment, the mounting face 322 is on a lower face of the insulating housing 30 and the mating face 321 is on an upper face of the insulating housing 30, that is, the mating face and the mounting face are disposed opposite to each other. The mounting faces 122, 322 are adapted for confronting with corresponding printed circuit board.

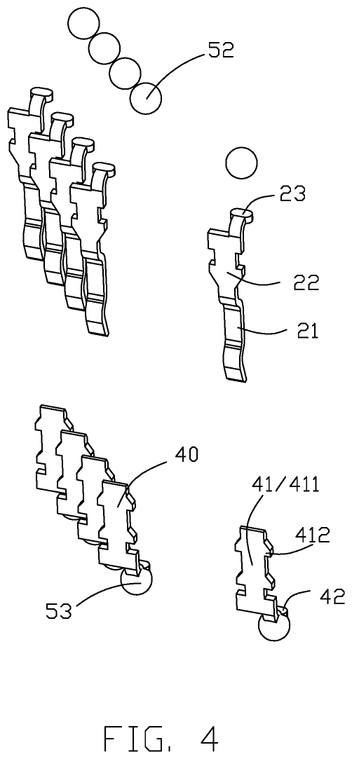

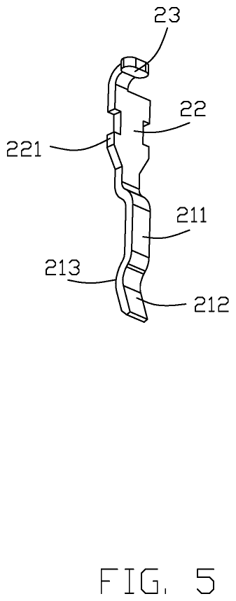

Referring to FIGS. 4-5, each of the terminals 20 of the first connector 100 includes a retaining portion 22, an elastic arm 21 extending from one end of the retaining portion 21 and a board-mounting portion 23 extending from another end of the retaining portion 22. The board-mounting portions 23 are retained on a printed circuit board via soldering balls 52. The elastic arm 21 has a mating portion 213. In this embodiment, the elastic arm 21 includes an upright portion 211 offset from the retaining portion 21 and an arc portion 212 extending from the upright portion. The arc portion 212 and the upright portion 211 protrude in two opposite direction. The mating portion 213 is defined on the peak of the arc portion 212 and having a mating face perpendicular to the mating direction. The mating portion 213 and the retaining portion 22 are disposed on a substantial upright line. Referring to FIGS. 2-3, the passageway 13 includes a retaining slot 131 and a receiving hole 132 communicating with each other. The retaining portions 22 are retained in the retaining slots 131. The lower portions of the elastic arms 21 extend into the receiving holes 131. The upper portions of the elastic arms 21 with the mating portions 213 expose to the receiving cavity 11 as best shown in FIG. 1.

The passageway 33 of the second connector 200 also includes a retaining slot 331 and a receiving hole 332. The terminals 40 are of a blade shape, and each includes a retaining portion 41 and a board-mounting portion 42, the retaining portion 41 provides a plane mating face 411 at a side face thereof and two barbs 412 at two edge faces thereof. The board-mounting portions 42 are retained on a printed circuit board via soldering balls 53. The retaining portions 41 are retained in the retaining slot 331, the plane mating faces 411 face the receiving hole 332. After the two connectors are engaged with each other, the second housing 30 is received in the receiving cavity 11, the elastic arms 21 are inserted in the receiving holes 322 and the mating portions 413 contact the mating face 411 of the second terminals 40. As best shown in FIG. 1, the elastic arms 21 slant in the receiving holes 332 of the second housing 30.

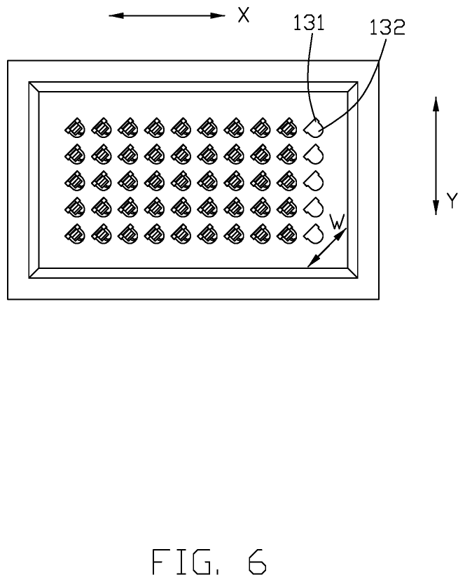

As best shown in FIG. 1 and FIG. 6, the insulating housing 10 extends in a height or mating direction, a longitudinal or first direction X and a transverse or a second direction Y perpendicular to each other. The passageways 13 are disposed in an array in the longitudinal direction X and in the transverse direction Y. Seen in the mating direction as best shown in FIG. 6, each row of the receiving slots 131 are arranged in the longitudinal direction X, plural rows of the receiving slots 131 are arranged in the transverse direction Y. Each retaining slot 131 is disposed in a diagonal direction W, the diagonal direction W is angled with the longitudinal direction X and the transverse direction Y. The receiving hole 132 is perpendicular to the retaining slot 131. The retaining portions 22 are disposed in the diagonal direction W. The board-mounting portions 22 are located just below the receiving holes 132 as best shown in FIG. 1.

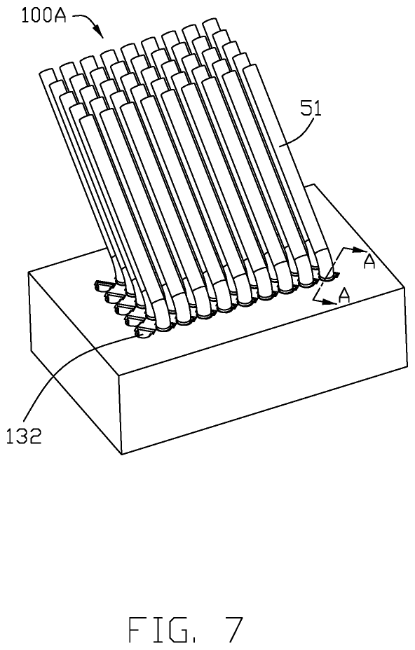

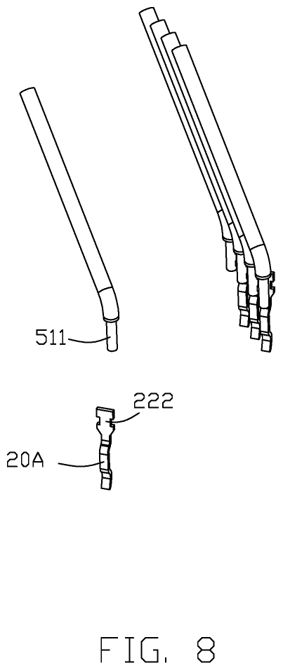

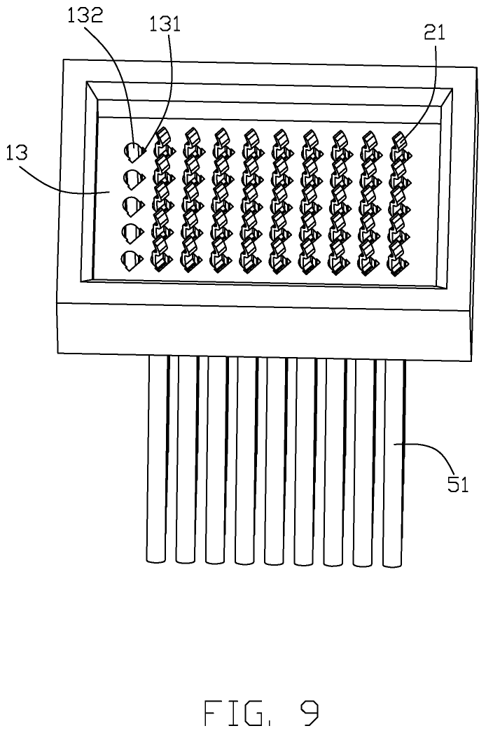

FIGS. 7-10 illustrating a second embodiment of the first connector 100A, the insulating housing is same to the first embodiment, and the terminals 20A is similar to the first embodiment. The terminals 20A are used to connect with cables 51. The terminals 20A have no board-mounting portions. The retaining portions 21 are retained in the retaining slots 131 and one side face 222 of the retaining portion 22 exposed to the receiving holes 132. The conductive ends 511 of the cables 51 are inserted into the receiving holes 132 and contact with the side face 222 of the retaining portion 22. Soldering process can be applied on the conductive ends 511 and the retaining portions 22 to get a further stability thereof. Each row of the cables 51 are arranged in longitudinal direction and plural rows of the cable are arranged in the transverse direction. All cables 51 extend away from the insulating housing in one orientation of the transverse direction.

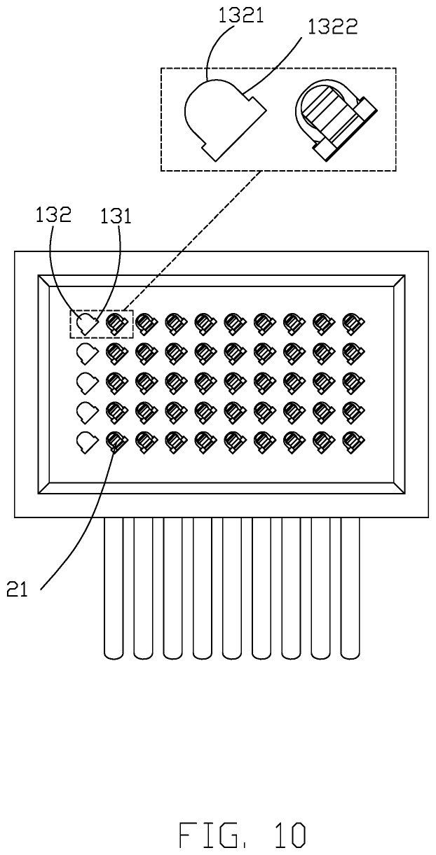

Understandably, the housing with the passageways 13 can be used in the board-mounting connector or the cable-mounting connector. As shown in FIG. 10, the receiving hole 132 has a hemicycle part 1321, which are suitable for receiving the conductive ends 511 of the cables when the terminals have no leg and used to connect with cables. Seen in the mating direction, the line of the receiving hole 132 includes a hemicycle line 1321, two straight lines 1322 jointing two opposite ends of the hemicycle line 1321. The conductive end 511 is sandwiched between the hemicycle part 1321 and the side face 222 of the retaining portion. In this embodiment, the retaining portions 22 provide cable-contacting faces so that the conductive ends 511 are preliminarily positioned in corresponding receiving holes by the hemicycle part 1321 and the cable-contacting face.

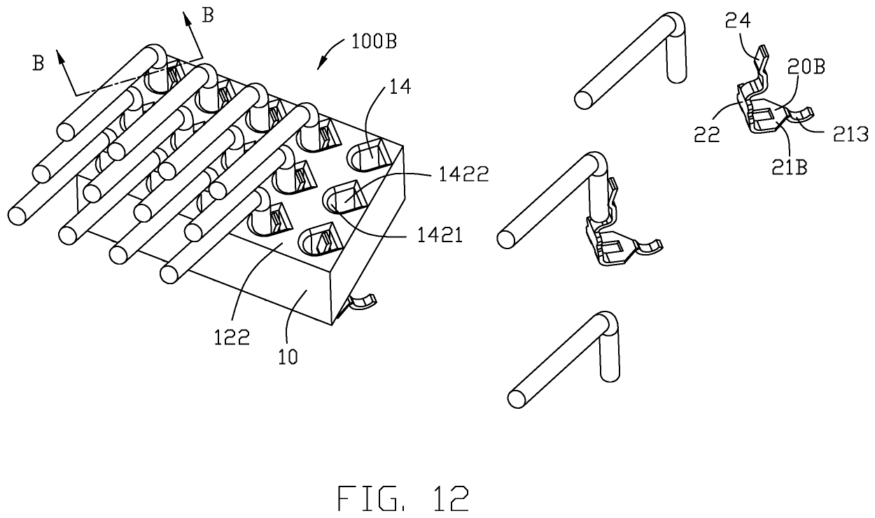

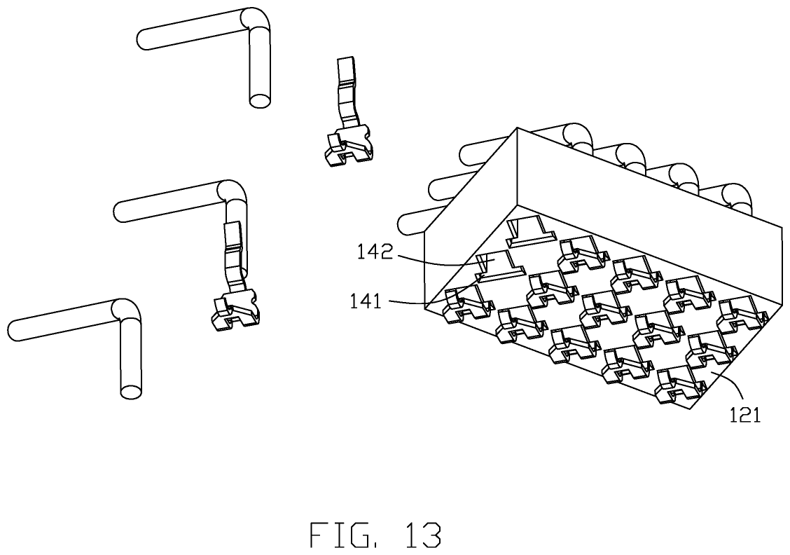

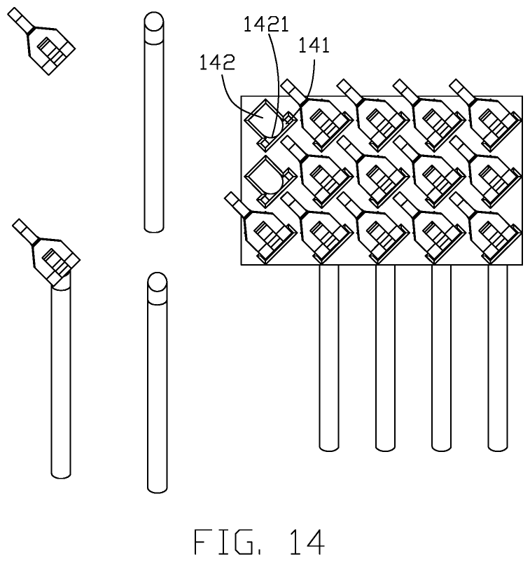

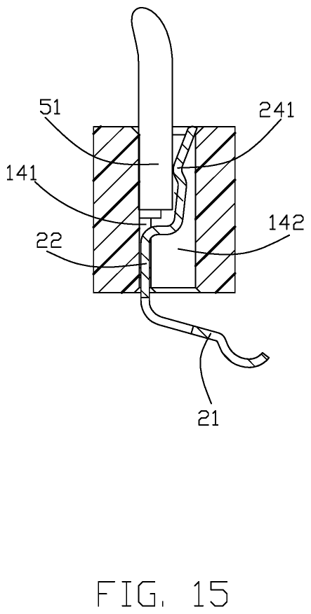

FIGS. 12-15 illustrating a third embodiment of the first connector 100B, the first connector 100B has a plurality of passageways 14 running through the mating face 121 and the mounting face 122. The terminal 20B includes a retaining portion 22 retained in the retaining slot, an elastic arm 21B with a mating portion 213 extending from the retaining portion 22, and an elastic leg 24 extending from the retaining portion 22. The elastic arms 21 extend out of the mating face 121 and expose to an exterior of the insulating housing 10. The elastic leg 24 extends into the receiving holes 132. A protruding portion 241 is formed near a distal end of the elastic leg 24, which faces towards the receiving holes 132. The conductive ends 511 of the cables are inserted into the receiving holes 132, and sandwiched between and by the protruding portions 241 and the inside of the receiving holes 142. Please notes, the receiving slots 142 do not run through the mounting face 122, a hemicycle portion 1421 of the receiving hole is located above the retaining slot 141, the protruding portion 241 is in the rectangle part 1422 of the receiving holes and faced the hemicycle portion 1421 of the receiving hole 132. In this embodiment, the elastic legs provide cable-contacting face which press against the conductive ends of the cables, the conductive ends are preliminarily positioned in corresponding receiving holes by the hemicycle par and the cable-contacting face.

However, the disclosure is illustrative only, changes may be made in detail, especially in matter of shape, size, and arrangement of parts within the principles of the invention.

What is claimed is:

1. An electrical connector comprising:
an insulating housing defining a mating face and a mounting face opposite to the mating face and having a plurality of passageways arranged in an array and running through the mating face and the mounting face, each passageway having a retaining slot and a receiving hole communicating with each other; and
a plurality of terminals each comprising a retaining portion retained in the retaining slot, a mating portion, and a cable-contacting face oriented at the receiving hole; wherein
viewed in a mating direction of the electrical connector, each of the receiving hole has a hemicycle part;
the terminals are adapted to connect with soldering balls or cables; and
the hemicycle parts and corresponding cable-contacting faces position conductive ends of the cables when the terminals are connected with the cables.

2. The electrical connector as claimed in claim 1, wherein each of the terminals comprises an elastic leg extending out of the mounting face of the insulating housing, and the cable-contacting face is defined on a side face of the retaining portion.

3. The electrical connector as claimed in claim 2, wherein the insulating housing defines a receiving cavity, and each of the terminals has an elastic arm extending into the receiving cavity and a mating face perpendicular to the mating direction.

4. The electrical connector as claimed in claim 3, wherein the elastic arm comprises an upright portion extending from the retaining portion and an arc portion extending from the upright portion, the upright portion is offset from the retaining portion, and the upright portion and the arc portion protrude in two opposite directions perpendicular to the mating direction.

5. The electrical connector as claimed in claim 1, wherein the hemicycle parts are located directly opposite to corresponding retaining slots.

6. The electrical connector as claimed in claim 1, wherein each of the terminals comprises an elastic leg located in the receiving hole, and the cable-contacting faces are defined on corresponding elastic legs.

7. The electrical connector as claimed in claim 6, wherein the elastic leg extends from the retaining portion and has a protruding portion orienting the hemicycle part, and the contacting portions are defined on the protruding portions.

8. The electrical connector as claimed in claim 7, wherein the retaining slots do not running through the mounting face, and the hemicycle parts are located above corresponding retaining slots.

9. The electrical connector as claimed in claim 1, wherein the receiving hole has two straight parts jointing with opposite ends of the hemicycle part.

10. The electrical connector as claimed in claim 1, wherein viewed in the mating direction, the retaining slots are arranged in a first direction and a second direction perpendicular to each other, each retaining slot is disposed in a diagonal direction angled with the first direction and the second direction and the receiving hole is perpendicular to the retaining slot, and the insulating housing is designed for the cables to extend out in the second direction.

11. An electrical connector comprising:
an insulating housing defining a mating face and a mounting face opposite to the mating face and having a plurality of passageway running through the mating face and the mounting face, each passageway having a retaining slot and a receiving hole communicating with each other;
a plurality of terminals each comprising a retaining portion retained in the retaining slot, a mating portion, and a cable-contacting face which orients the receiving hole; and
a plurality of cables comprising exposed conductive ends;
wherein the receiving hole has a hemicycle part, and the conductive ends of the cables are directly inserted in the receiving holes and positioned between the hemicycle parts and corresponding cable-contacting faces of the terminals.

12. The electrical connector as claimed in claim 11, wherein the cable-contacting face is defined on a side face of the retaining portion.

13. The electrical connector as claimed in claim 12, wherein each of the terminals comprises an upright portion extending from the retaining portion and an arc portion extending from the upright portion, the upright portion is offset from the retaining portion, the upright portion and the arc portion protrude in two opposite directions perpendicular to the mating direction, and the arc portion has the mating portion.

14. The electrical connector as claimed in claim 11, wherein the hemicycle parts are located directly opposite to corresponding retaining slots.

15. The electrical connector as claimed in claim 11, wherein each of the terminals comprises an elastic leg located in the receiving hole, and the cable-contacting faces are defined on corresponding elastic legs.

16. The electrical connector as claimed in claim 15, wherein the retaining slots do not running through the mounting face, and the hemicycle parts are located above corresponding retaining slots.

17. An electrical connector comprising:
an insulating housing defining a mating face and a mounting face opposite to the mating face and having a plurality of passageway running through the mating face and the mounting face, the passageways are arranged in an array along a first direction and a second direction, each passageway comprising a retaining slot and a receiving hole at a first side of the retaining slot and communicating with the receiving slot;
a plurality of terminals each comprising a retaining portion retained in the retaining slot and a mating portion; and
a plurality of cables inserted into corresponding receiving holes and connected with corresponding terminals;
wherein the retaining slot extends in a diagonal direction angled with the first direction and the second direction, and the cables extend out of the insulating housing in the second direction.

18. The electrical connector as claimed in claim 17, wherein the terminals comprise elastic arms with the mating portions, and the elastic arm extends in the diagonal direction.
